(19) United States
(12) Patent Application Publication
(10) Pub. No.: US 2024/0076088 A1
(43) Pub. Date: Mar. 7, 2024

(54) METHOD AND APPARATUS FOR INSPECTING CONTAINER CLOSURES ARRANGED ON CONTAINERS

(71) Applicant: KRONES AG, Neutraubling (DE)

(72) Inventor: Michael JOGSCH, Barbing (DE)

(21) Appl. No.: 18/241,648

(22) Filed: Sep. 1, 2023

(30) Foreign Application Priority Data
Sep. 1, 2022 (DE) 10 2022 122 219.5

(51) Int. Cl. B65C 3/08; B65D 1/02; B65D 41/34; B67C 3/02; G06T 7/00; G06T 7/73

(52) U.S. Cl. CPC B65C 3/08; B65D 1/0246; B65D 41/3428; B67C 3/02; G06T 7/001; G06T 7/74; B65D 2203/02; G06T 2207/30108; G06T 2207/30204

(57) ABSTRACT

Disclosed is a method for producing containers filled with beverages, wherein a container closure has a closure cap screwed onto a mouth of the container, a securing device arranged in a longitudinal direction of the container below the mouth, a connecting strand which connects the securing device to the closure cap, a first fastening section which the connecting strand is attached to the closure cap, and a second fastening section which the connecting strand is arranged on the securing device, wherein the containers are transported using a transport device and are inspected using an inspection device, wherein a rotational position of the container closure relative to the container and/or a rotational position of the container is determined, wherein after the inspection, the containers are provided with a label and/or a print, wherein the determined rotational position of the container closure is taken into account.

### BACKGROUND OF THE INVENTION

The present invention relates to a method and an apparatus for producing containers filled with liquids.

In the field of the beverage producing industry, it is known that machines initially fill containers and then close them with closures. An essential criterion is the question of whether the container closures are screwed properly or sealingly onto the mouths or the threads of the containers. Furthermore, it is also known that these containers are provided with a print or a label after they have been filled.

DE 10 2008 044 926 A1 discloses an apparatus and a method for aligning a container. EP 1 427 639 B1 describes a labeling device. A method and an apparatus for inspecting containers provided with closures are known from DE 10 2021 121 489 which is yet to be published.

Furthermore, a series of inspection systems is known from the prior art. It is therefore known that markings are applied both to the containers themselves and to the closures, which markings can be detected by an inspection device, and information about a rotational position of the container and the closure is therefore obtained.

By comparing these markings or their rotational positions, it is possible to infer the state of the closure. For example, disposable PET containers and their screw closures have unique markings. The marking(s) is (are) arranged in a fixed relation to a thread orientation. If the container closure is applied correctly, the two markings must be at a certain angle to one another (in particular an angle relative to the container axis or the longitudinal direction of the container) or in a different type of relationship. Manufacturing and application tolerances are defined by the permissible tolerated spacing of the two markings. As long as the closure and container markings lie within these tolerances, it is ensured that the sealing concept (closure and mouth piece) works correctly.

Usually, markings which have a fixed relationship to the phase position of the thread in the closure piece and are applied as visually inconspicuously as possible are arranged on the closure. For example, it is known that part of a knurled region is somewhat shortened.

It is usual to use support ring markings or markings in the neck region below a support ring on the containers, which markings have a fixed relationship to the phase position of the thread on the mouthpiece. The containers preferably have a support ring. The containers are preferably produced from a transparent material, for example PET.

The closures commonly used to date are usually without a logo or embossing on the cover. If such features were present, it was not certain that they were in a phase relationship with the thread in the mouthpiece.

A new type of closures is now known, so-called tethered caps. What these have in common is that they have some form of lasso function. This function has the effect that the closure remains connected via the lasso to the retaining ring arranged on the container, even after it has been opened.

In the prior art, this closure with its “lasso” is arranged randomly relative to a print or label of the container. Accordingly, all possible angular offsets between the label or print and the closure are possible.

Therefore, the “lasso” projects in all possible directions, and an untidy impression arises when the container is viewed.

The object of the present invention is therefore to provide a method and an apparatus which enable the production of containers with such closures which give a uniform overall impression, in particular with regard to the arrangement of a label and/or the arrangement of the closure.

This is achieved according to the invention by the subject matter of the independent claims. Advantageous embodiments and developments are the subject matter of the dependent claims.

### SUMMARY OF THE INVENTION

To ensure that the closure can still remain compact, the lasso or the section referred to below as the connecting strand should not be longer than necessary. From this it follows that the lasso or connecting bar or connecting strand should have a certain minimum length, but should also be no longer than necessary. In other words, the bar or strand or lasso will be just long enough so that upon being screwed on, the bar or strand can work upon reaching the end of the thread. Technically, this lasso function preferably has a fixed relationship to the closure thread.

In a method according to the invention for producing containers filled with beverages and provided with container closures or to be provided (with container closures), wherein the container closure has a closure cap screwed (or to be screwed) onto a mouth of the container, a securing means arranged on the container in a longitudinal direction of the container below the mouth, at least one connecting strand and/or connecting bar connecting the securing means to the closure cap, a first fastening section on and/or with which the connecting strand is fastened to the closure cap, and a second fastening section on and/or with which the connecting strand is fastened to the securing means, wherein the containers are transported by means of a transport device and are inspected by means of an inspection device (and/or observed with an observation device), wherein a rotational position of the container closure relative to the container and/or a rotational position of the container closure and/or a rotational position of the container are determined.

Advantageously, a rotational position of the container closure is determined with respect to above the container and/or with respect to a longitudinal direction of the container, in particular from a position of the connecting strand and/or a position of at least one fastening section.

The invention can be used for containers which are already provided with container closures and are equipped, for example labeled or printed, in this state. In this case, a rotational position of the container closure or the container is preferably detected.

In addition, however, the invention is also possible for containers that have not yet been closed and/or filled. In this case, a rotational position of the container can be detected. Since the containers are always screwed onto the containers in a specific way, a defined rotational position of the container closure also follows after the (proper) closing of the container.

In an advantageous method, on the one hand a rotational position of the container and/or of the container closure is determined; on the other hand, however, a rotational position of the container closure relative to the container is also determined. In this case, it is possible that a rotation and/or rotational position of the container closure with respect to the container is determined and, preferably, a first marking (or a feature) located on the container is detected and/or recorded in order to determine the rotational position.

In this way, it is possible for the same inspection or observation device to be able to deduce both an (in particular absolute) rotational position of the closure and whether the closure is correctly arranged on the container.

According to the invention, after the inspection of the containers, the containers are provided with a label, a colored container direct print by inkjet and/or a print (marking), wherein the determined rotational position of the container closure and/or the container is taken into account while providing them.

Therefore, a way is proposed of providing the features, for example a label or a print, not at an arbitrary position on the container, but at a position which is oriented relative to the container closure at a predetermined position.

Several possibilities exist for detecting this rotational position. First, it is possible to detect the rotational position of the closure itself (with respect to a longitudinal direction of the container). However, it would also be possible to detect the rotational position of the container (with respect to its longitudinal direction). With a properly closed container, the closure is arranged in a defined rotational position on the container. For this reason, the rotational position of the container closure can also be deduced from the rotational position of the container.

Preferably, the securing means is a securing ring which preferably always remains on the container independent of an opening state of the container. In this case, it is possible for this securing ring to be in connection with the closure cap when the container is in a still unopened state, and to be separated from the closure cap by the first opening process and then preferably be spaced apart from the closure cap in the longitudinal direction of the container. Preferably, this securing ring is rotatable relative to the container (in particular substantially free).

The fastening section is preferably a joint section on which the connecting strand is arranged on the closure cap or the securing means.

In a preferred method, the rotational position of the container closure is determined from a position of the connecting strand and/or a position of at least one fastening section.

In a preferred method, the information from which the rotational position of the container closure relative to the container is derived is not determined by markings affixed to the container closure for this purpose, but the connection strand or the fastening of the securing means is used for this purpose.

It is therefore advantageously proposed that, in the new type of tethered caps described, their lasso function or the connecting strand is used as a feature on the closure, and/or the rotational position is detected by detecting this lasso function.

This lasso function can be implemented differently from closure manufacturer to closure manufacturer. Nevertheless, the basic principle of the fixed phase relationship of the lasso or connecting strand to the thread in the closure remains the same. Depending on the type of container closure, however, this phase relationship may vary.

In a preferred method, a 360° detection of the container closure is used. This detection can preferably detect both the closure and the connecting strand as well as parts thereof. This detection may also detect the type of closure or connection strand (technical implementation, the manufacturers, closure locations).

In a preferred method, an offset between the container closure (or its rotational position) and the container (or its rotational position) or generally a correction value is determined on the basis of this information.

In a further preferred method, a rotational position of the container closure and/or a correction value is determined on the basis of this information.

In a preferred method, a visual feature is used to inspect the connection between the container closure and the container and/or to detect a rotational position of the container closure.

In a further preferred method (in particular after the inspection), the container provided with the closure is aligned with regard to its longitudinal direction with respect to its rotational position and, in particular, is rotated by a predetermined angle with respect to the longitudinal direction.

In this method, the rotational position of the closure and/or of the container is accordingly detected, and the container is oriented on the basis of this detected rotational position and in particular rotated by a predetermined angle with respect to its longitudinal direction.

In an advantageous method, the predetermined angle is determined taking into account the determined rotational position of the container closure. In this way it is possible for the inspection device to detect a specific rotational position of the closure or of the container. This rotational position can then be compared with a target rotational position, and the container can be aligned or rotated in such a way that the closure reaches the target rotational position.

Preferably, the containers are each provided with features in a (substantially) identical rotational position of the closure, i.e., in particular printed or labeled.

Preferably, labeling is carried out while the container with the closure arranged thereon is in a target rotational position which was achieved in particular by an alignment.

In a further preferred method, a rotational position of the container closure is detected and compared with a target rotational position.

The container is then preferably rotated until the target rotational position has been reached. In so doing, it is possible for the container to always be rotated only in one direction of rotation for alignment. In this way, a rotation about angles of rotation of 0-360° could take place.

However, it would also be possible for a rotational angle to be determined by which the container has to be rotated, and then to decide in which direction the container is rotated. In this way, the container is rotated only by a maximum of 180°.

In a further preferred method, the alignment takes place in such a way that the provided feature on the container is opposite the connecting strand. Accordingly, if the front side of the container, i.e., the section on which the center of a print or a label is located, faces an X direction, the connecting strand preferably extends at the rear side of the container and preferably in the X direction.

It is therefore proposed within the scope of the invention that the aforementioned lasso and/or its position is detected, and thereafter the container with the closure (for example in a labeling machine) is rotated or aligned in such a way that the lasso is always at the correct angle to the feature still to be applied, e.g. the label. Preferably, the lasso points in exactly the opposite direction compared to a front label.

In a preferred method, the container is first closed and then labeled.

However, as mentioned above, it is also possible that first a rotational position of the container and in particular of a thread of the container is detected (for example, a thread or other feature may be inspected), and then the label or print is applied at a certain angle thereto. The container closure follows later, wherein the position of the lasso inevitably results from the internal thread of the container closure. This is particularly true in interlocked machines.

Preferably, when the container is in a manufactured state, the connecting strand points approximately to the rear and the label or print is at the front.

Preferably, therefore, the inspection device or observation device optically determines the rotational position of the container closure. In a preferred method, at least one image of the container closure and/or the connecting strand and/or the fastening section(s) is recorded.

Preferably, this is a spatially resolved image. In particular, at least one fastening section and in particular the first fastening section is inspected.

However, it would also be possible for several properties of the connection between the container closure and the securing means to be inspected, in particular in order to refine and or check a corresponding image evaluation. The type of the container closure can also be deduced from these features.

In a further preferred embodiment, the container closure has an internal thread. Preferably, the container itself has an outer thread.

Preferably, the mentioned features (i.e., the connecting strand and/or the fastening sections) are in a fixed phase relationship with the thread of the closure. This phase relationship can differ depending on the container closure, however, it is advantageously predetermined for any type of container closures.

In a further preferred method, a type of container closures is also determined by means of the inspection device, or at least one value is determined which is characteristic of this type. Particularly preferably, the container closure and/or its type is (in particular clearly) identified.

For each container closure, a reference value for example a reference value for an offset (in particular between the thread and the connecting strand and/or the fastening sections) can be specified.

Preferably, a type of the container closure is therefore taken into account for determining the rotational position of the container closure relative to the container. An offset between the feature, i.e., the position of the connecting strand and/or the fastening section(s) and the thread of the container closure can preferably be taken into account.

In a particularly preferred method, a type of container closure is predefined and/or is determined and/or taken into account, and a value is determined therefrom which is characteristic of a relative position between a thread of this closure and the thread.

For example, it can be known for container closures of type A that a start of a thread is rotated by +30° relative to the position of the connecting strand, while the corresponding rotational angle is +10° for container closures of type B. These values can be used in the evaluation of a determined rotational position.

In a further preferred method, the container is transported during the inspection. In a further preferred method, the container and/or the container closure is illuminated during the inspection and in particular for recording an image with a lighting device such as a flash lamp.

In a further preferred method, the container is a plastic container and in particular a plastic bottle. In a further preferred method, the container or containers are closed by means of at least one closing member, preferably a plurality of closing members, prior to inspection.

In this case, it is possible for the operating mode of individual closing members to be corrected and/or changed within the scope of the inspection. In a further preferred method, defective closed containers are discharged from the transport path of the containers.

In a further preferred method, at least one image of an upper side of the container is recorded. This can be, for example, a complete image of the container closure and/or a 360° image.

In a further advantageous method, the marking located on the container is received by the same inspection device, such as the position of the connecting strand and/or the position of the fastening section or sections. Alternatively, however, it would also be possible for the container closure to be recorded by a first inspection device, and the container itself or the marking located on the container to be recorded by a further inspection device.

Preferably, from at least one recorded image of the container closure, a position of the container closure is inferred with respect to the container and, in particular, a rotational position of the container closure with respect to a longitudinal direction of the container.

In a further advantageous method, the inspection device determines at least one further property characteristic of the container closure and/or of its arrangement on the container.

In a particularly preferred method, this further property is selected from a group of properties which contains a color of the container closure, a type of the container closure, an orientation of the container closure on the container, damage to the container closure or the container, and the like. Accordingly, for example, a container closure arranged incorrectly or slanted on the container can also be recognized by the inspection.

In a further preferred method, the inspection device records at least one spatially resolved image of the container and/or the container closure. Preferably, an evaluation device determines from this image the position of the container closure on the container or the correct orientation. Artificial intelligence can be used for the evaluation. Preferably, a signal is output which is characteristic of a correct and/or incorrect rotational position of the container closure relative to the container.

In addition, it is also possible for an image to be evaluated by comparing it with reference images. Artificial intelligence may also possibly be used here. The container is preferably inspected in its longitudinal direction and/or perpendicular to its longitudinal direction. This makes it possible for the container to also be recorded (for example by the use of a mirror cabinet) from several sides and preferably from all sides.

In a further preferred method for inspecting the container and/or the container closure, an optical system and/or a mirror cabinet is preferably used. Particularly preferably, at least two cameras or image recording devices and preferably at least three cameras or image recording devices are used for inspecting the container closure and/or the container.

In a further preferred method, the detection of the container closure described here can also perform other testing tasks as mentioned above, such as the presence of a container closure, a missing closure, a poorly seated closure and the like.

In a further preferred method, the image of the container closure is recorded entocentrically, telecentrically or pericentrically. In addition, more than six image recording devices or cameras can also be used for inspection. In addition, a further image recording device or cameras can also be used which recognize another marking of the closure, for example a logo and/or a brand of its manufacturer.

Particularly preferably, the marking is detected on the container, for example on its support ring or below this support ring in the same unit or in a further additional and/or dedicated unit. Preferably, the two positions of the features are determined in one or also in several evaluation devices or computing units, or also in an outsourced evaluation device and/or computing unit. If detection takes place at different transport location positions, this should preferably be taken into account when assigning the evaluation results.

Together with an assignment of the closing member, the error and also the twist angle of each individual closing member can be visually parameterized, controlled and/or regulated. The corresponding closing member which has arranged this closure on the container can also preferably be identified when errors arise.

The present invention accordingly preferably allows reliable detection of the orientation of a thread in a closure without an auxiliary mark that is required in the prior art. Together with the feature on the container, a stable and robust detection of the closure rotation angle position can be determined. In addition, a real seal detection of the container is thereby possible.

The invention can be combined together with other useful checks listed above in one unit. The present invention therefore also works even with difficult colors or container closures.

The present invention further directed to an apparatus for producing containers filled with beverages and provided or to be provided with container closures, wherein the container closure has a closure cap to be screwed onto a mouth of the container (or a closure cap screwed onto the container), a securing means to be arranged (or arranged) on the container below the mouth in a longitudinal direction of the container, a connecting strand connecting the securing means to the closure cap, a first fastening section on and/or with which the connecting strand is fastened to the closure cap, and a second fastening section on and/or with which the connecting strand is arranged on the securing means.

Furthermore, the apparatus has a transport device for transporting the containers along a predetermined transport path and an inspection device for inspecting the containers provided with the container closures and/or an observation device for observing the containers provided with the container closures (in particular during said transport, i.e., during the movement of the containers), which are suitable for determining a rotational position of the container closure relative to the container, and/or a rotational position of the container closure and/or a rotational position of the container.

In the context of the present application, the terms container closure and closure are used synonymously, and the closure cap is a component of the container closure.

According to the invention, the apparatus has a feature providing device downstream from the inspection device in the direction of transport, which apparatus provides the container with a feature, in particular a label and/or an print, wherein the apparatus is suitable and intended for providing this feature of the container taking into account the rotational position of the container closure.

In a further advantageous embodiment, the apparatus has an alignment device which aligns the containers with respect to their rotational positions in relation to their longitudinal directions, wherein the alignment device preferably takes the rotational position into account in this alignment. This alignment device is preferably arranged downstream from the inspection device in the transport direction of the containers. Preferably, this alignment device is arranged in front of the feature providing device in the transport direction of the containers. Particularly preferably, the transport from alignment recognition to the feature providing device is subject to a forcibly-guided container transport, i.e., the container rotation position is always known after detection.

Preferably, this alignment device is suitable and intended for rotating the containers into a target rotational position in which said containers are provided with a feature, in particular labeled and/or printed.

In a preferred embodiment, the alignment device has two lateral guide strips. In addition, however, the alignment device can also have gripping elements which grip the containers by their mouths to rotate them. In addition, the alignment device can also be a component of the feature providing device which provides the containers with a feature, and in particular rotates them. In this way, synergies can be used, since in many cases the containers are also rotated with respect to their longitudinal direction for the purpose of or while being provided with a feature.

Preferably, the alignment takes place in the labeling or marking device of the containers.

Preferably, the apparatus also has a filling device which fills the containers with a liquid and in particular a beverage.

Preferably, the apparatus has a closing device which closes the filled containers with a container closure and, in particular, a container closure of the type described above.

In a preferred embodiment, the filling device is arranged in front of the inspection device in the transport direction of the containers. Preferably, the closing device is also arranged upstream from the inspection device.

In this embodiment, the containers are accordingly first filled and closed and subsequently labeled.

However, it would also be possible for the filling device and/or the closing device to be arranged downstream from the inspection device and in particular also from the feature providing device or labeling device. In this case, the still empty containers are preferably inspected in order to thereby detect their rotational position.

The inspection device advantageously determines the rotational position of the container closure from a position of the connecting strand and/or a position of at least one fastening section.

It is therefore also proposed in terms of the apparatus that an element which connects the closure cap to the securing means is used to determine the rotational position. In this way, the evaluation or detection of the rotational position can be directed to a feature of the closure that is already technically necessary.

In a further advantageous embodiment, the apparatus has a closure device which closes the containers with the closures.

In a further advantageous embodiment, the apparatus has an image evaluation device which is suitable and intended for outputting, from at least one of the recorded images, at least one value which is characteristic of an angular position of the connecting strand and/or at least one fastening section.

The present invention is also directed to a container, in particular a beverage container having a container closure, wherein the container closure has a closure cap screwed onto a mouth of the container, a securing means (12b) arranged on the container in a longitudinal direction of the container below the mouth, a connecting strand connecting the securing means to the closure cap (12a), a first fastening section at which the connecting strand is fastened to the closure cap, and a second fastening section (12e) with which the connecting strand is arranged on the securing means, and wherein the container also comprises a provided feature, in particular in the form of a print or a label.

According to the invention, the container is produced by a method of the type described above and/or by an apparatus of the type described above.

The provided feature is preferably opposite the connecting strand. The container is preferably a plastic container.

### BRIEF DESCRIPTION OF THE DRAWINGS

Further advantages and embodiments result from the accompanying drawings. In the figures:

FIG. 1a, b show two schematic representations of a container closure;

FIG. 2 shows a representation of a container closure arranged on a container;

FIG. 3 shows a representation of an apparatus according to the invention in a first embodiment;

FIG. 4 shows a schematic representation of an image recorded with the apparatus from FIG. 3;

FIG. 5 shows a representation of an apparatus according to the invention in a second embodiment;

FIG. 6 shows a schematic representation of an image recorded with the apparatus from FIG. 5;

FIG. 7 shows an apparatus according to the invention in a first embodiment; and

FIG. 8 shows an apparatus according to the invention in a second embodiment.

### DETAILED DESCRIPTION OF THE INVENTION

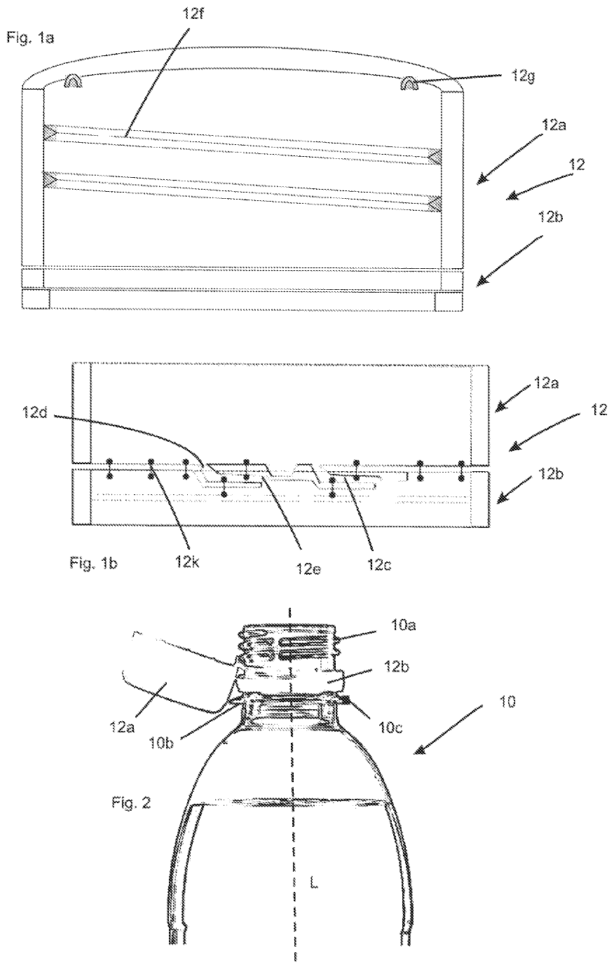

FIGS. 1a and 1b show a representation of a container closure 12. This has a closure cap 12a, in the interior of which an (inner) thread 12f is arranged in order to screw the closure cap onto a corresponding external thread of a container. The reference sign 12g designates a sealing means which, in a closed state of the container, seals the closure 12 with respect to the container, more precisely with respect to the mouth edge of the container.

The reference sign 12b indicates a securing ring which remains on the container even in a screwed-on state. The reference sign 12c indicates a connecting strand via which the securing ring 12b remains connected to the closure cap 12a. The reference signs 12d and 12e indicate the respective fastening sections in which the connecting strand is fastened to the closure cap and to the securing ring. These fastening sections can be designed as joint sections.

The reference sign 12k indicates a connection formed as a predetermined tearing point between the closure cap and the securing ring, which is torn when the container is first opened. Preferably, a plurality of such predetermined tearing points is formed in the circumferential direction with respect to the container closure.

FIG. 2 shows a representation of a container closure 12 arranged on a container 10. This container 10 extends in the longitudinal direction L and has an external thread 10a. The reference sign 10b designates a support ring, and the reference sign 10c designates a marking arranged on this support ring 10b, which marking can be optically detected by an inspection device so that a rotational position of the container can be deduced.

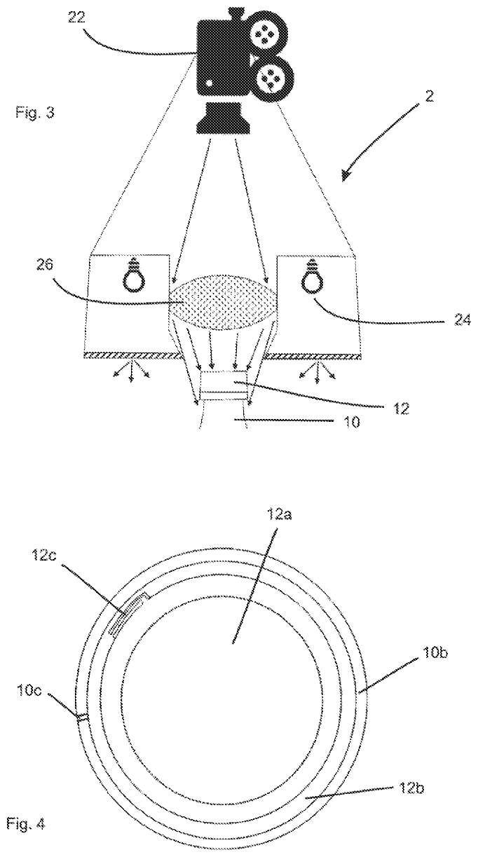

FIG. 3 shows a schematic representation of an inspection device which is part of the apparatus according to the invention in a first embodiment. An image recording device 22 is arranged above the container 10 in the longitudinal direction of the latter. This records an image of the container closure arranged on the container by means of a lens.

In suitable combination, the lens and the objective of the image recording device create a pericentric image and/or are to be regarded jointly as a pericentric objective. Pericentric objectives are special objectives in metrology.

In contrast to conventional objectives, the beam path on the object side is not divergent, but convergent. This makes it possible to observe objects through an objective from several directions at the same time. Pericentric objectives are used, for example, to capture the entire circumferential surface and the front surface of a cylinder with one camera. The mouthpiece of the container and the closure is approximately a cylindrical body.

The reference sign 24 designates a lighting device which is in the shape of a ring and accordingly fully illuminates the container closure.

In all of the embodiments described here, the image recording device preferably records an image of an illuminated container closure, so that an inspection is performed in each case using the reflected light method.

FIG. 4 shows an image recorded by the image recording device 22. The closure cap 12a can be seen as well as the support ring 10b of the container. The marking 10c on the support ring can also be seen in the recorded image.

In addition, the connecting strand 12c can be seen in the image here. In this way, an image evaluation device can determine the rotational position of the connecting strand 12c relative to the rotational position of the marking 10c. In this way, it is possible to infer the rotational position of the container closure relative to the container. In addition, an image evaluation device can also determine the rotational position of the connecting strand approximately in the form of an angular position. This rotational position can be compared with a target position.

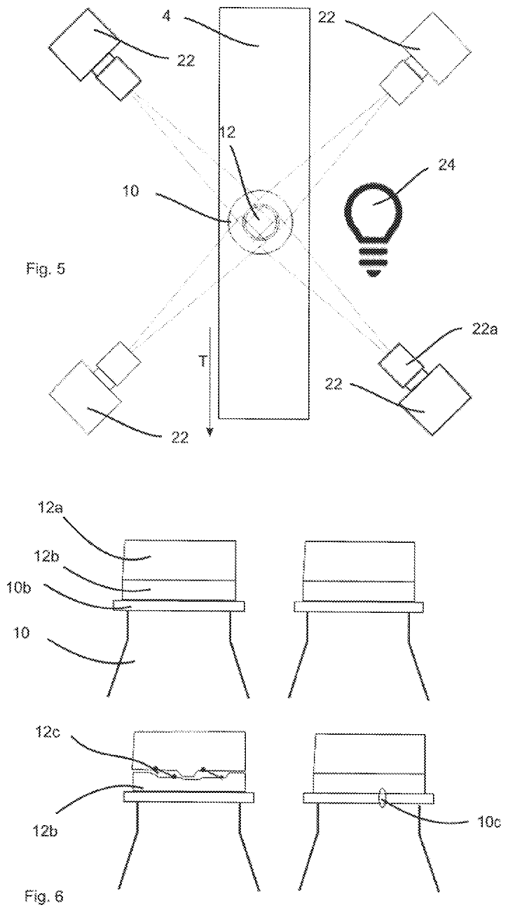

FIG. 5 shows a schematic representation of an apparatus 1 according to the invention in a second embodiment. In this embodiment, several image recording devices or cameras 22, in this case four, observe the container in a direction predominantly perpendicular to the longitudinal direction of the container. In addition, a lighting device 24 is also provided here.

The cameras can record at the same time and synchronously with the (flash) illumination. The illumination preferably consists of a monolithic unit or of several segments in the monolithic unit, for example, for the purpose of adapting the illumination to various closure types and or colors.

In addition, the illumination can be distributed locally in the detection. It is possible for each camera to record individually, or for a subgroup of cameras to record with an individual subset of the lighting. It is possible that the individual images of the camera are executed in rapid succession over time.

Preferably, the time interval between the individual images is less than ms, preferably less than 5 ms, particularly preferably less than 2.5 ms. This has the advantage that the container is moved as little as possible. Furthermore, it is possible for one or more cameras to achieve quasi-simultaneous incident and transmitted light images by individually controlling the illumination setup. Particularly preferably, the images are taken simultaneously by all image recording devices.

It is advantageous if the setup is adapted to a specific closure location or also to a closure color.

The reference sign 4 designates a transport device which transports the containers 10 along a transport path T (rectilinear in this case). The imaging of the containers is preferably triggered on the transport device. The transport device is preferably designed as a conveyor belt.

FIG. 6 shows the four images recorded by the image recording devices 22. The connecting strand 12c can be seen in one image, and the marking 10c on the support ring can be seen in a further image. By evaluating these images, the position of the connecting strand 12c relative to the marking 10c can be inferred, and accordingly the rotational position of the container closure 12 relative to the container 10. In addition, it is also possible to infer an absolute rotational position of the connecting strand.

However, the inspection device described here is also suitable for detecting a rotational position of a container not yet provided with a container closure. This can be done, for example, by detecting the marking 10c.

A closing device, which closes the containers 10 with the container closures 12 or screws the container closures onto the containers, is preferably provided upstream from the inspection devices shown in FIGS. 3 and 5.

The container closures described within the scope of this invention are preferably screw closures which are particularly preferably made of plastic.

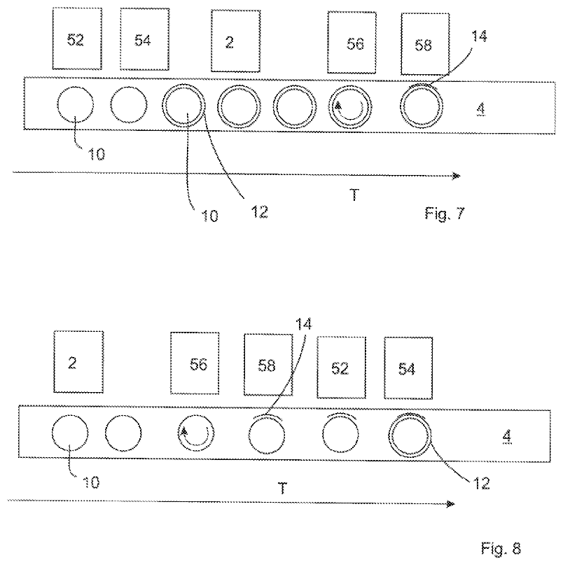

FIG. 7 shows a schematic representation of an apparatus 1 according to the invention. In this embodiment, a transport device is provided which transports the containers 10 along a transport path T.

The reference sign 52 designates a filling device which fills the containers with a liquid. This filling device is adjoined by a closing apparatus 54 which provides the containers 10 with container closures 12.

The reference sign 2 designates the inspection device which inspects the containers provided with the container closures and, in particular, detects a rotational position of the container closure on the basis of the lassos and/or a rotational position of the container along the longitudinal direction L.

In addition, it is also possible for this inspection device 2 to check both the rotational position of the container closures 12 and the rotational position of the containers 10, and in this way it can be determined whether the containers are properly closed.

Optionally, the apparatus can also have a rejection device that rejects containers that are not properly closed from the transport path. This rejection device is arranged downstream from the inspection device.

The reference numeral 56 designates an alignment device which aligns the containers 10 with respect to their rotational position. The reference sign 58 designates a feature providing device such as a labeling device which applies a feature to the containers, in this case a label 14.

FIG. 8 shows a further embodiment of the present invention. In this embodiment, the inspection device 2 inspects the still unclosed containers 10 with respect to their rotational position. Subsequently, the alignment device 56 rotates the still closed containers and the feature providing device, in this case a labeling device, and provides the feature, here labels 14, on the container. Subsequently, the filling device 52 fills the containers, and the closing device brings container closures 12 to the containers.

It would also be possible to initially fill and close the containers and only then provide them with a feature by the feature providing device.

A person skilled in the art will recognize that further modifications of the sequence are possible. Preferably, however, the inspection device 2 is provided first along the transport path, followed by the alignment device and then the feature providing device (although further units may be located between these devices).

The closing apparatus is preferably also provided directly after the filling device.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. A method for producing containers filled with beverages and provided with or to be provided with container closures, wherein the container closure has a closure cap screwed onto a mouth of the container, a securing means arranged in a longitudinal direction of the container below the mouth on the container, a connecting strand which connects the securing device to the closure cap, a first fastening section on which the connecting strand is attached to the closure cap, and a second fastening section with which the connecting strand is arranged on the securing device, wherein the containers are transported using a transport device and are inspected by an inspection device, wherein a rotational position of the closure cap is determined relative to the container, and/or a rotational position of the container closure, and/or a rotational position of the container,
wherein
after the inspection of the containers, the containers are provided with a label and/or a print, wherein the determined rotational position of the container closure is taken into account for this provided feature.

2. The method according to claim 1,
wherein
the rotational position of the container closure is determined from a position of the connecting strand and/or a position of at least one fastening section.

3. The method according to claim 1,
wherein
after inspection, the container provided with the closure is aligned with regard to its rotational position with respect to its longitudinal direction and is rotated by a predetermined angle with respect to the longitudinal direction.

4. The method according to claim 3,
wherein
the predetermined angle is determined taking into account the determined rotational position of the container closure.

5. The method according to claim 3,
wherein
the alignment is carried out in such a way that the provided feature on the container is opposite the connecting strand.

6. The method according to claim 1,
wherein
at least one image of an upper side of the container closure is recorded.

7. The method according to claim 1,
wherein
the inspection device determines at least one additional characteristic property of the container closure and/or its arrangement on the container, and the additional property is selected from a group of properties which includes a color of the container closure, a type of the container closure, an orientation of the container closure on the container, damage to the container closure or to the container.

8. The method according to claim 1,
wherein
the inspection device records at least one spatially resolved image of the container and the container closure.

9. The method according to claim 1,
wherein
the container is inspected in its longitudinal direction and/or perpendicular to its longitudinal direction.

10. The method according to claim 1,
wherein
a type of the container closure is taken into account for determining the rotational position of the container closure.

11. An apparatus for producing containers filled with beverages and provided with or to be provided with container closures, wherein the container closure has a closure cap screwed onto a mouth of the container, a securing means arranged in a longitudinal direction of the container below the mouth on the container, a connecting strand which connects the securing device to the closure cap, a first fastening section on which the connecting strand is attached to the closure cap, and a second fastening section with which the connecting strand is arranged on the securing device, having a transport device which transports the containers along a predetermined transport path, and having an inspection device for inspecting the containers provided with the container closures, which is suitable for determining a rotational position of the container closure relative to the container and/or a rotational position of the container closure,
wherein
the apparatus has a feature providing device downstream from the inspection device in the transport direction which provides the container with a label and/or a print, wherein the apparatus is configured for providing this feature for the container taking into account the rotational position of the container closure or a thread orientation.

12. The apparatus according to claim 11,
wherein
the apparatus has an alignment device which aligns the containers with regard to their rotational positions with respect to their longitudinal directions.

13. The apparatus according to claim 11,
wherein
the apparatus has a closing device which closes the containers with closures.

14. The apparatus according to claim 11,
wherein
the apparatus has an image evaluation device which is configured for outputting, from at least one of the recorded images, at least one value which is characteristic of an angular position of the connecting strand and/or at least one fastening section.

15. A container with a container closure, wherein the container closure has a closure cap screwed onto a mouth of the container, a securing device arranged in a longitudinal direction of the container below the mouth on the container, a connecting strand which connects the securing device to the closure cap, a first fastening section at which the connecting strand is fastened to the closure cap and a second fastening section with which the connecting strand is arranged on the securing device, and wherein the container further has a provided feature,
wherein
the container is produced by a method according to claim 1.

16. A container with a container closure, wherein the container closure has a closure cap screwed onto a mouth of the container, a securing device arranged in a longitudinal direction of the container below the mouth on the container, a connecting strand which connects the securing device to the closure cap, a first fastening section at which the connecting strand is fastened to the closure cap and a second fastening section with which the connecting strand is arranged on the securing device, and wherein the container further has a provided feature,
wherein
the container is produced by an apparatus according to claim 11.
